(19) United States
(12) Patent Application Publication
(10) Pub. No.: US 2006/0230416 A1
(43) Pub. Date: Oct. 12, 2006

(54) Systems and methods for event triggered advertising

(76) Inventors: Robert Brazell, Salt Lake City, UT (US); Robert H. Powell, Idaho Falls, ID (US)

Correspondence Address: Kirton & McConkie, 1800 Eagle Gate Tower, 60 East South Temple, Salt Lake City, UT, 84111, US

(21) Appl. No.: 11/365,405

(22) Filed: Mar. 1, 2006

Related U.S. Application Data
(60) Provisional application No. 60/657,994, filed on Mar. 2, 2005.

(51) Int. Cl. H04N 7/025

(52) U.S. Cl. 725/34

(57) ABSTRACT

Systems and methods of event triggered advertising where at least one embodiment includes an event monitoring module, an advertising database, and an advertising vehicle. The event monitoring module identifies and characterizes events based on a plurality of content variables. The advertising database stores a plurality of advertisements with particular content variables. The event monitoring module then determines if a particular event's content variable settings sufficiently match the content variables of an advertisement stored in the advertising database. If the event monitoring module determines there is a sufficient match, the corresponding advertisement is broadcast via the advertising vehicle. Each of the processes may be performed manually or automatically depending on available resources.

### RELATED APPLICATIONS

This application claims priority to U.S. Provisional Patent Application Ser. No. 60/657,994, filed Mar. 2, 2005, entitled SYSTEMS AND METHODS FOR EVENT TRIGGERED ADVERTISING.

### BACKGROUND

1. Field of the Invention

The present invention relates to systems and methods for event triggered advertising. More particularly, the present invention relates to triggering related advertising upon the occurrence of an event.

2. Background of the Invention and Related Art

Advertising is the process through which companies attempt to convince customers to purchase their products. Advertising takes many forms including radio advertisements, in-store audio advertisements, television advertisements, billboards, etc. The production and broadcasting of these advertisements has become more and more expensive. Companies wish to maximize the effect of their advertisements by determining the most effective message to promote. Numerous marketing textbooks and classes discuss this field.

One problem associated with advertising is its inability to target immediate and temporary desires of customers. Most advertising is aimed at particular customer demographics that consistently purchase a particular product. For example, it may be determined that middle-aged males shop for gardening tools and therefore gardening tool advertisements are created that are directed at middle-aged males. This however does not address a possible temporary desire felt by a large population to purchase gardening tools when the weather is ideal for working outside. Therefore, there is a need in the industry for a system of triggering related advertising in response to a particular event.

### SUMMARY OF THE INVENTION

The present invention relates to systems and methods of event triggered advertising. One embodiment relates to a system that includes an event monitoring module, an advertising database, and an advertising vehicle. The event monitoring module identifies and characterizes events based on a plurality of content variables. The advertising database stores a plurality of advertisements with particular content variables. The event monitoring module then determines if a particular event's content variable settings sufficiently match the content variables of an advertisement stored in the advertising database. If the event monitoring module determines there is a sufficient match, the corresponding advertisement is broadcast via the advertising vehicle. In some embodiments, the event monitoring module is configured to receive events from an operator who becomes aware of the occurrence of a meteorological, geological, political, sporting or other event of note and reports the event to the event monitoring module. Each of the processes may be performed manually or automatically depending on available resources.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a representative system that provides a suitable operating environment for use of the present invention;

FIG. 2 illustrates an operational diagram of a system for broadcasting a related advertisement in response to an event in accordance with one embodiment of the present invention;

FIG. 3 illustrates a flow chart of a method for broadcasting a related advertisement in response to an event in accordance with one embodiment of the present invention;

FIG. 4 illustrates one embodiment of the act of receiving and characterizing an event, shown in FIG. 3;

FIG. 5 illustrates one embodiment of the act of determining if an event matches a stored advertisement, shown in FIG. 3; and

FIG. 6 illustrates one embodiment of the act of broadcasting a matching advertisement, shown in FIG. 3.

### DETAILED DESCRIPTION OF THE PREFERRED EMBODIMENTS

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention relates to systems and methods of event triggered advertising. One embodiment relates to a system that includes an event monitoring module, an advertising database, and an advertising vehicle. The event monitoring module identifies and characterizes events based on a plurality of content variables. The advertising database stores a plurality of advertisements with particular content variables. The event monitoring module then determines if a particular event's content variable settings sufficiently match the content variables of an advertisement stored in the advertising database. If the event monitoring module determines there is a sufficient match, the corresponding advertisement is broadcast via the advertising vehicle. Each of the processes may be performed manually or automatically depending on available resources. While embodiments of the present invention are directed at systems and methods of event triggered advertising, it will be appreciated that the teachings of the present invention are applicable to other areas.

As used in this specification, the following terms are defined accordingly:

“event”—is an occurrence that may affect how and what customers purchase. For example, a tornado may cause customers to purchase emergency food rations. Also, the first snowfall may cause customers to purchase winter clothing, snow shovels, and salt to aid in snow removal, snow tires and other related goods. In addition, an athletic team's success may cause fans to purchase team paraphernalia, highlight videos, season tickets and donate money to the team's institution, as well as cause fans to purchase other team-related goods. In addition, natural catastrophes, such as hurricanes, may cause people in non-affected areas of the world to purchase care kits containing supplies to send to the victims of the catastrophes. Another example is graduation from school, which may cause relatives and friends to purchase gifts for the graduates.

“content variable”—a variable that is associated with the event itself. For example, the tornado event may have an associated emergency supply variable. Various types of variables may be used to store this information including but not limited to alphanumeric, numeric, digital, analog, Boolean, etc.

“in-store advertisement”—an advertisement that is broadcast within a store environment. For example, an advertisement broadcast over the store loadspeaker regarding a particular deodorant.

“in-store media”—the various media within a store through which an in-store advertisement can be broadcast.

“comparison algorithm”—a particular formula for analyzing at least one variable setting between a stored advertisement and an event to determine if there is a match.

The following disclosure of the present invention is grouped into two subheadings, namely “Exemplary Operating Environment” and “Event-Triggered Advertising.” The utilization of the subheadings is for convenience of the reader only and is not to be construed as limiting in any sense.

### Exemplary Operating Environment

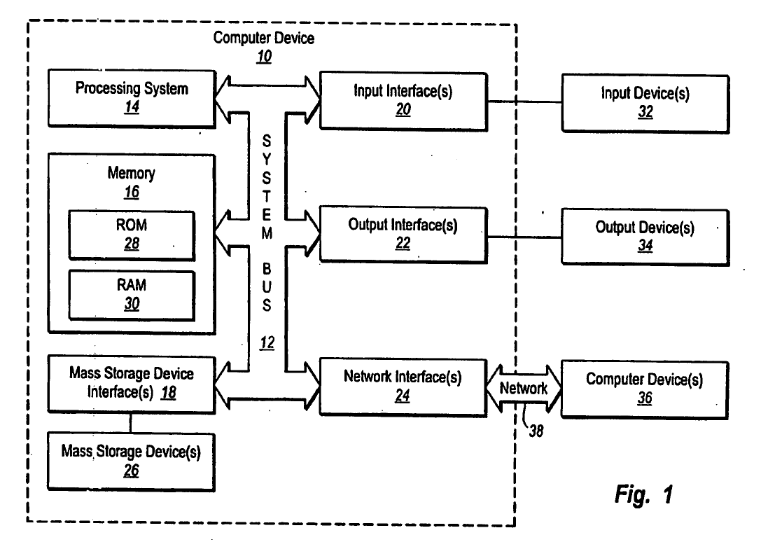

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. Alternatively, the invention may also be practiced in whole or in part manually following the same procedures. Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below. Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Event-Triggered Advertising

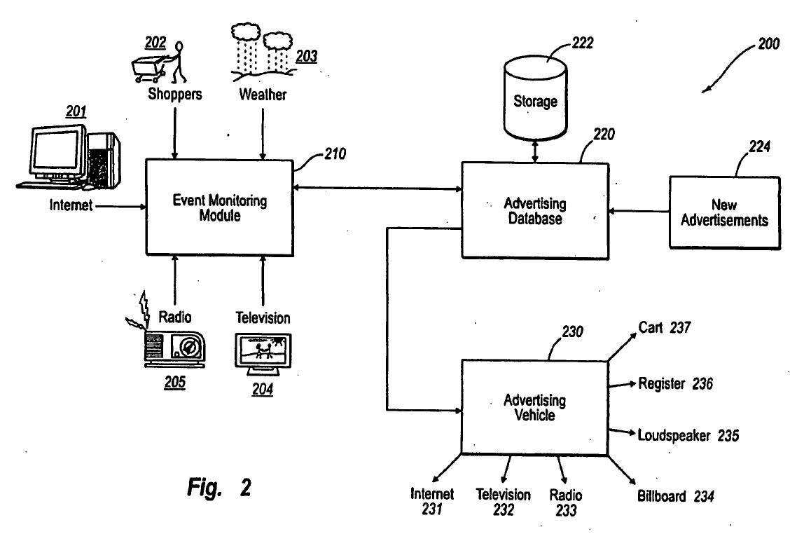

Reference is next made to FIG. 2, which illustrates an operational diagram of a system for broadcasting a related advertisement in response to an event in accordance with one embodiment of the present invention. The system is designated generally as 200. The system includes an event monitoring module 210, an advertising database 220, and an advertising vehicle 230. One of the functions of the event monitoring module 210 is to receive events from various sources. An event is any occurrence which may affect how and what a customer purchases. As illustrated, the event monitoring module 210 receives events from a plurality of media and other sources. The illustrated media sources include internet 201, shoppers 202, weather 203, television 204, and radio 205. Naturally, additional media sources may be added and remain consistent with the present invention. The internet 201 in particular further includes numerous sources of obtaining news, weather, promotional and other types of events including RSS feeds and associated press feeds. Likewise, shoppers 202 may personally relay promotional events such as a clown performing inside the store. Additional in-store promotional events may also be input into the event monitoring module 210, including the start of an automatic, live, personal, or video product demonstration. Likewise, the entrance of a scheduled product demonstrator or demonstration device may be input as an event to the event monitoring module 210. These additional in-store events may be relayed by a demonstration calendar (not shown), manually entered by a store employee, or relayed to the event monitoring module 210 in some other manner. The weather 203 may also be a source for weather events such as rain or snow which may cause customers to wish to purchase particular clothing items. Television 204 and radio 205 broadcast a large amount of information which can be used to obtain various types of events. Various filtering techniques can be used to isolate events from other media broadcasts.

The event monitoring module 210 also assigns at least one content variable to each event. A content variable is a variable that relates to the event itself and how it may affect customers. For example, the event of snow may include a content variable related to warm clothing or hot chocolate. In addition, an athletic team's success in a sporting event may include a content variable related to that team's paraphernalia. This variable may be a single alphanumeric string or a plurality of digital bits corresponding to different events. The event and corresponding content variable are then temporarily stored for comparison purposes.

The advertising database 220 stores multiple advertisements in some form of storage 222. The advertising database 220 is also configured to received new advertisements 224 and assign each new advertisement at least one content variable corresponding to an event. For example, an advertisement for hot chocolate may include a content variable related to cold temperatures. Or, an advertisement for a sports team's paraphernalia may include a content variable related to the outcome of the team's most recent event. The advertising database 220 can be configured to store a wide variety of advertisements including billboard, audio, video, internet, smell, etc.

The advertising vehicle 230 is a device that is configured to broadcast an advertisement over at least one media. The illustrated embodiment shows internet 231, television 232, radio 233, billboard 234, loudspeaker 235, register 235, and cart 237. Naturally various forms of advertising can be broadcast over particular media. For example, the internet 231 can be used to broadcast pop-up advertisements and banner advertisements. The register 235 refers to a particular type of in-store advertisement that is located near the register. Likewise, the cart 237 is an in-store advertisement located on the shopping cart.

In operation, the event monitoring module 210 receives an event and assigns at least one content variable. The event and at least one corresponding content variable are compared to the stored advertisements in the advertising database 220. If a stored advertisement is matched to an event, the stored advertisement will be routed to the advertising vehicle 230 for broadcasting over at least one form of media.

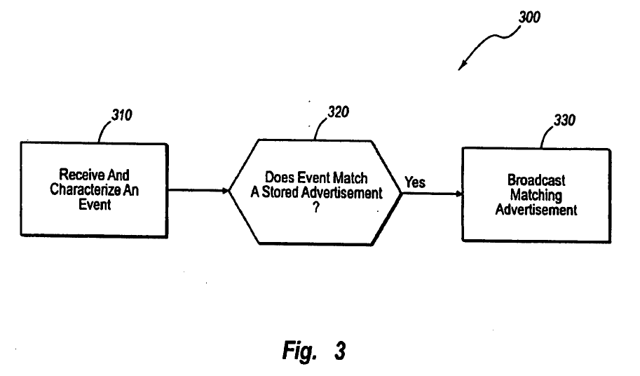

Reference is next made to FIG. 3, which illustrates a flow chart of a method for broadcasting a related advertisement in response to an event in accordance with one embodiment of the present invention. The method is designated generally at 300. The method includes receiving and characterizing an event, act 310. As discussed with reference to FIG. 2, events may be received from a plurality of media and other sources. The characterization refers to the assignment of at least one content variable to each event. The method then analyzes whether the event matches a stored advertisement, act 320. This analysis utilizes a comparison algorithm to compare at least one content variable between the event and various stored advertisements. If a matching stored advertisement is identified, the method proceeds to broadcast the matching advertisement, act 330.

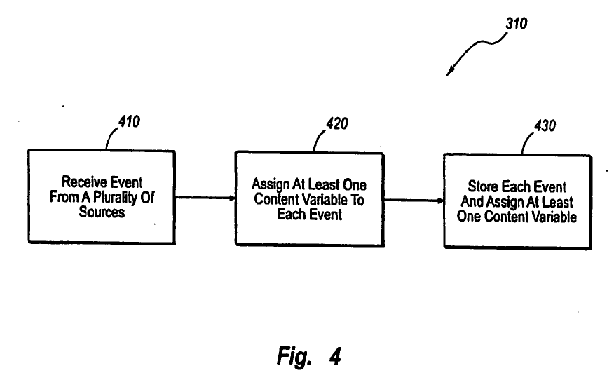

Reference is next made to FIG. 4, which illustrates one embodiment of the act of receiving and characterizing an event, shown in FIG. 3. An event is received from one of a plurality of media sources, act 410. As discussed above, the plurality of media sources can include a wide variety of media and other sources. In addition, various filtering techniques may be used to identify the relevant events in a particular media stream. Each event is then assigned at least one content variable, act 420. The content variables relate to how a particular event may affect customers. The at least one content variable may be created in a wide variety of formats and remain consistent with this invention. Each event and assigned at least one content variable is then stored, act 430. The storage of the events and content variables is temporary for the purpose of comparison. The events and content variables may be deleted upon completion of an event.

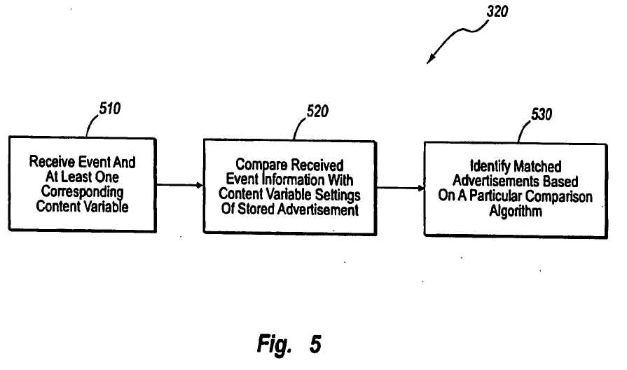

Reference is next made to FIG. 5, which illustrates one embodiment of the act of determining if an event matches a stored advertisement, shown in FIG. 3. An event and corresponding at least one content variable are received, act 510. Various forms of data transfer may be used to temporarily store events and content variables. The at least one content variable setting of the event is compared to at least one content variable of the various stored advertisements, act 520. Matching advertisements are then identified using a particular comparison algorithm, act 530. One type of comparison algorithm could only allow for a match if the content variables of the event and the advertisement precisely match. Alternatively, a comparison algorithm could allow for matches between tangentially related content variables. For example, a cold weather content variable may be associated with a power outage content variable.

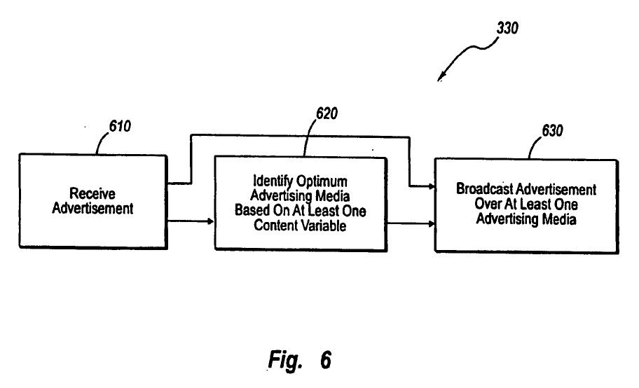

Reference is next made to FIG. 6, which illustrates one embodiment of the act of broadcasting a matching advertisement, shown in FIG. 3. The advertisement is received from some form of advertising storage, act 610. Optionally, an optimum advertising media may be identified based on the at least one content variable of the advertisement, act 620. For example, if the content variable is cold weather, video may be a more effective advertising media than audio. The advertisement is then broadcast over at least one advertising media, act 630.

Thus, as discussed herein, the embodiments of the present invention relate to systems and methods for event triggered advertising. More particularly, the present invention relates to triggering related advertising upon the occurrence of an event. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. A system for broadcasting a related advertisement in response to an event, comprising:
an advertising database configured to store at least one advertisement;
an advertising vehicle that is configured to broadcast an advertisement via at least one advertising media; and
an event monitoring module configured to receive events from an operator who becomes aware of the occurrence of a meteorological, geological, political, sporting or other event of note and reports the event to the event monitoring module, said module then determining if the event properly matches an advertisement stored in the advertising database, and routes advertisements that match the event to corresponding ads in the advertising database to the advertising vehicle.

2. The system of claim 1, wherein the advertising database is also configured to receive new advertisements, assign at least one content variable to the new advertisements, and store the new advertisements.

3. The system of claim 1, wherein the advertising media includes any form of in-store media.

4. The system of claim 1, wherein the advertising media includes any one of internet, television, radio, billboard, loudspeaker, register, and cart.

5. The system of claim 1, wherein the event monitoring module compares at least one content variable setting of a stored advertisement with at least one assigned content variable setting of a received event to determine if they match.

6. The system of claim 1, wherein the event monitoring module utilizes a particular comparison algorithm to determine if an event matches a stored advertisement.

7. The system of claim 1, wherein the event monitoring module receives events through any one of a RSS feed, associated press, internet, television, weather, store schedule, radio, and manual entry.

8. The system of claim 1, wherein the event includes any one of a shopping event, weather event, holiday event, and promotional event.

9. A system for broadcasting a related in-store advertisement in response to an event, comprising:
an advertising database configured to store at least one in-store advertisement;
an advertising vehicle that is configured to broadcast an in-store advertisement via at least one advertising media; and
an event monitoring module configured to receive events, determine if the events properly match an in-store advertisement stored in the advertising database, and route matching in-store advertisements in the advertising database to the advertising vehicle.

10. A method for broadcasting a related advertisement in response to an event, comprising the acts of:
receiving an event;
characterizing the received event by assigning at least one content variable, wherein the acts of receiving an event and characterizing the received event by assigning at least one content variable further includes the acts of:
receiving event information from a plurality of sources;
assigning at least one content variable to the received event; and
storing the received event and corresponding at least one content variable;
comparing the at least one content variable setting of the received event with at least one content variable setting of a plurality of stored advertisements; and
if the at least one content variable setting of the received event matches at least one content variable setting of a stored advertisement, then broadcasting the matched stored advertisement.

11. The method of claim 10, wherein the plurality of sources includes any one of a RSS feed, associated press, internet, television, weather, store schedule, radio, and manual entry.

12. The method of claim 10, wherein the event is received via any one of a RSS feed, associated press, internet, television, weather, store schedule, radio, and manual entry.

13. The method of claim 10, wherein the act of determining if the at least one content variable setting of the received event matches at least one content variable setting of a stored advertisement further includes the acts of:
receiving an event and at least one corresponding content variable;
comparing the at least one variable setting of the received event with the at least one content variable setting of a stored advertisement; and
identifying at least one matched advertisement utilizing a particular comparison algorithm.

14. The method of claim 10, wherein the act of broadcasting the matched stored advertisement further includes the acts of:
receiving the matched advertisement;
identifying optimum advertising media based on the at least one content variable; and
broadcasting the matched advertisement over identified optimum advertising media.

15. The method of claim 10, wherein the act of broadcasting the matched stored advertisement further includes the acts of:
receiving the matched advertisement; and
broadcasting matched advertisement over at least one advertising media.

16. The method of claim 10, wherein the event includes any one of a shopping event, weather event, holiday event, and promotional event.

17. The method of claim 10, wherein at least one content variable setting includes any one of corresponding industry, corresponding products, corresponding demographics, and corresponding location.

18. The method of claim 10, wherein the stored advertisement is stored in an advertising database that receives advertisements and assigns at least one content variable.
